(19) United States
(12) Patent Application Publication
(10) Pub. No.: US 2003/0036326 A1
(43) Pub. Date: Feb. 20, 2003

(54) Flame retardant conductive material and producing method thereof

(75) Inventors: Susumu Takagi, Fukui (JP); Akihide Katayama, Fukui (JP); Sachiyo Sakagawa, Fukui (JP); Toru Takegawa, Fukui (JP)

Correspondence Address: Rocco S. Barrese, Esq., DILWORTH & BARRESE, LLP, 333 Earle Ovington Blvd., Uniondale, NY, 11553, US

(73) Assignee: SEIREN CO. LTD.

(21) Appl. No.: 10/218,000

(22) Filed: Aug. 13, 2002

(30) Foreign Application Priority Data
Aug. 13, 2001 (JP) 2001-245161

(51) Int. Cl. B32B 5/14; B32B 5/18; B32B 5/24; D04H 1/00

(52) U.S. Cl. 442/222; 442/371; 442/372; 442/376; 442/378; 442/223; 442/224; 442/232

(57) ABSTRACT

To a composite sheet in which on one or both surfaces of an open cell foam sheet fiber cloth is bonded, a conductive metal coating is provided so as to maintain the open cell of the foam followed by providing thereon a flame retardant composition, thereby a flame retardant conductive material suitable for a gasket material for electromagnetic wave shield is obtained.

### BACKGROUND OF THE INVENTION

1. Field of the Invention

The present invention relates to a flame retardant conductive material suitable for a gasket material for use in shielding the electromagnetic wave that leaks mainly from electrical and electronic equipment, and a producing method thereof.

2. Description of the Related Art

In recent years, so-called electronics equipment, such as personal computers, computer game and portable telephones, has been widely used and has prevailed even into ordinary home lives. As the applications thereof are expanded from industrial ones to general-purpose ones, there have been caused many problems in that the electromagnetic wave that leaks from the equipment causes malfunction in other electronics equipment, electromagnetic interference is caused on communication equipment, and so on. This has been one of recent journalistic topics.

In such social situations, in electronics industries of interest, in order to inhibit various kinds of interferences due to the electromagnetic wave that leaks from the aforementioned equipment from occurring, an electromagnetic wave shield material having an excellent shield effect is in demand, and sufficient flame retardant property is concurrently in demand.

In order to satisfy such demands, WO98/06247 proposes a conductive material for use in an electromagnetic wave shield gasket material that, in comparison with an existing electromagnetic wave shield material, can eliminate complicated producing works and thereby allow mass-producing, is lower in price, more uniform in quality and higher in reliability.

However, the conductive material disclosed in WO 98/06247 has disadvantages in that, for instance, at the occurrence of the fire, the material itself burns.

Accordingly, the present invention intends to provide a conductive material that, in comparison with the existing electromagnetic wave shield gasket material, can eliminate complicated producing works and thereby allows mass-producing, is lower in price, more uniform in quality and higher in reliability, in addition to the above, excellent in flame resistance; and a producing method thereof.

### SUMMARY OF THE INVENTION

In one aspect, the present invention provides a flame retardant conductive material comprising a composite sheet in which fiber cloth is bonded to one or both surfaces of an open cell foam sheet; a conductive metal coating adhered onto an overall surface of the composite sheet so as to maintain the open cell characteristics of the foam sheet; and a flame retardant composition adhered onto the metal coating.

In another aspect, the present invention provides a method for producing a flame retardant conductive material which comprises steps of; providing a composite sheet in which fiber cloth is bonded to one or both surfaces of an open cell foam sheet; adhering a conductive metal by means of plating so as to maintain the open cell characteristics of the foam sheet; and adhering a flame retardant composition of the obtained composite the flame sheet so that retardant layer is adhered on a substantial entire surface of the metal coating including the inner surface of the open cells.

### BRIEF DESCRIPTION OF THE DRAWINGS

FIG. 1 is a schematic diagram of a composite sheet of the present invention in which fiber cloth and an open cell synthetic resin foam sheet are laminated.

FIG. 2 is a schematic diagram of a composite sheet of the present invention in which fiber cloth is laminated on both surfaces of an open cell synthetic resin foam sheet.

FIG. 3 is a schematic diagram showing a measurement method of a surface resistance value in the present invention.

FIG. 4 is a schematic diagram showing a measurement method of a volume resistance value in the present invention.

In the drawings, reference numeral 1 denotes fiber cloth, 2 denotes an open cell foam sheet, 3 denotes a test piece, 4 denotes an electrode, 5 denotes a clamp and 6 denotes a tester.

### DESCRIPTION OF THE PREFERRED EMBODIMENTS

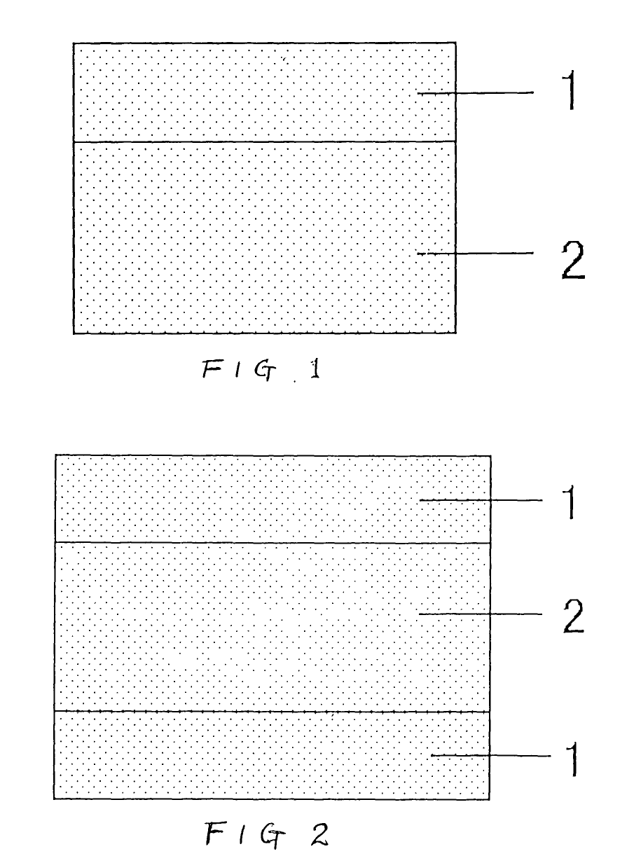

Typical examples of the composite sheet of the conductive material suitable for the electromagnetic wave shield gasket material of the present invention have sectional structures as shown in FIGS. 1 and 2. In the drawings, reference numeral 1 denotes fiber cloth and reference numeral 2 denotes an open cell synthetic resin foam sheet. Furthermore, in the present invention, the open cell synthetic resin foam sheet and fiber cloth are previously laminated to form an integrated composite sheet, the obtained composite sheet is provided with a conductive metal coating, the obtained composite sheet coated with the metal coating is further adhered with a flame retardant composition, and thereby a conductive material that is suitable for the electromagnetic wave shield gasket and has excellent flame resistance can be formed.

As the fiber cloth being used in the present invention, fiber cloth such as woven fabric, knitted fabric, nonwoven fabric and so on made of organic fiber or inorganic fiber can be exemplified.

As examples of the organic fiber, chemical fibers such as synthetic fiber, semi-synthetic fiber, regenerated fiber, and natural fibers such as plant fiber, animal fiber and so on can be used. However, in particular, synthetic fibers such as polyamide fibers such as nylon 6 and nylon 66, polyester fibers such as polyethylene terephthalate and so on, and acrylic fibers are preferably used, among these, polyester fiber such as polyethylene terephthalate and so on are preferable.

Furthermore, as the inorganic fiber, metal fibers, carbon fibers, glass fibers and so on can be used, among these, the carbon fibers are preferable in view of bonding resistance and so on.

Among the above fibers, in view of productivity, handling properties and cost, the polyester fibers such as polyethylene terephthalate and so on are particularly preferable.

When the polyester fibers are used, a multi-filament whose single fiber is 0.11 to 5.6 denier is preferable. When the single fiber is smaller than 0.11 denier, the fiber cost becomes expensive, on the other hand when it is larger than 5.6 denier, the fiber cloth becomes less flexible. In addition to the above, the weight of the fiber cloth is preferable to be in the range of 10 to 100 g/m².

In order to assuredly fix the metal coating onto the fiber cloth, it is preferable to previously completely remove impurities such as a sizing agent, oil, dust and so on due to a scouring process.

Next, the foam sheet used in the present invention is an open cell foam sheet and preferable to be open cell soft synthetic resin foam sheet having an excellent compression stability. Examples of the foam sheet that has these characteristics include polyethylene foam, polypropylene foam, polyvinyl chloride foam, polyurethane foam, polyimide foam, polybutadiene foam and silicone foam. In a foam sheet having a cell film on a surface thereof, the cell film may be preferably removed.

Accordingly, when both of soft type and hard type are available as in the case of polyurethane foams, the soft type foam should be selected.

The foam sheet used in the present invention is required to have open cells.

There is no particular restriction on a content of the open cells, and the foam sheet whose content of the open cells is usually 10% or more, more preferably 30% or more, still more preferably 50% or more, the most preferably 80% or more can be used.

In the present invention, the conductive metal coating is necessary to be formed not only on an outer surface of the composite sheet but also in the inside thereof, in particular, in the inner surface of the open cells of the foam sheet. For this, a cell density is preferable to be in the range of from 20 to 100 units/inch. When the cell density is less than 20 units/inch, sufficient electromagnetic wave shield effect cannot be obtained, and when it is more than 100 units/inch, the metal coating cannot be sufficiently formed into the inside of the foamed sheet, and thereby there may occur a problem in mechanical strength of the foam sheet.

Next, as a method for integrally laminating the foam sheet and the fiber cloth to obtain a composite sheet, there can be exemplified one method in which a conductive adhesive is coated on a surface of either a foam sheet or fiber cloth followed by laminating the other one thereon to adhere, alternatively when the foam sheet is thermoplastic type, another method in which immediately after at least part of a surface of the foam sheet is thermally fused, the fiber cloth is laminated thereon to adhere, a so-called melt-bonding method.

When the metal coating is formed on the composite sheet, in order to secure sufficient conductivity at a portion through which the foam sheet and the fiber cloth are adhered, the melt-bonding method can be preferably used. In the melt-bonding method, a surface portion of, for instance, polyurethane foam sheet, after it is directly melted with a gas flame, is laminated with the fiber cloth and adhered thereto, and thereby a composite sheet can be obtained. In this case, the foam sheet is preferably melted up to substantially 0.3 to 1 mm from the surface of the foam sheet. When it is melted 0.3 mm or less, sufficient adhesive strength cannot be obtained, in contrast when it is melted 1 mm or more, the production cost tends to rise. When the metal coating is formed on the composite sheet produced according to the melt-bonding method, the metal coating is formed not only inside of the fiber cloth and foam sheet, but also inside of the melt-bonded layer portion of the foam sheet. Accordingly, conductivity at a portion bonding between the synthetic resin open cell foam sheet and the fiber cloth becomes improved.

When the metal coating is applied on the composite sheet, the plating method is usually preferably used because thin metal coating can be formed as uniform as possible into the inside so that the open cell structure of the foam can be maintained. After pre-treatment such as addition and activation of a catalyst is performed as in the ordinary plating, the conductive metal, such as Ag, Ni, Cu, Au or the like, is electroless plated, or after the electroless plating, electroplated.

It is preferable for the metal coating to be formed on the composite sheet with a thickness in the range of 0.01 to 2 μm. When it is formed thinner than 0.01 μm, sufficient shield characteristics may not be obtained, in contrast, when it is formed thicker than 2 μm, not only the shield characteristics cannot be further improved, but also the metal coating becomes less filexible.

A thickness of the composite sheet coated with the metal coating, though different depending on its applications, is usually preferable to be in the range of 0.5 to 7 mm. When it is smaller than 0.5 mm, a sufficient elasticity may not be obtained, resulting in difficulty in obtaining effect, in contrast, when it is larger than 7 mm, the flame resistant effect becomes smaller and the cost becomes higher.

Subsequently, a flame retardant composition is attached onto the metal coating formed as mentioned above. The flame retardant composition is attached to composite sheet in the form of a binder resin solution. As method for attaching the flame retardant composition, there are a spray method, coating methods such as a knife coat method and a slit roll method, and an immersion method in which after the composite sheet is immersed in a resin solution containing the flame retardant composition, an excess resin is removed. Among these, in view of uniformly attaching the flame retardant composition to the composite sheet, the immersion method is preferably used. Furthermore, the following may be combined with the above: synthetic resins for use in the formation of a foam before foaming, after the flame retardant is added thereto, may be foamed, alternatively fibers constituting the fiber cloth may be previously blended with the flame retardant.

As binder resin for fixing the flame retardant composition onto the metal coating, water-soluble resins and emulsion-forming resins are preferable. Polyester resins, acrylic resins, urethane resins, silicone resins and so on can be cited.

As the flame retardants, there are bromine based flame retardant, phosphorus based flame retardants, antimony based flame retardants and soon. As the bromine based flame retardant, aromatic bromine compounds such as bis(pentabromophenyl)ethane, bis(tribromophenyl)ether, bis(pentabromophenyl)ether are preferable, as the phosphorus based flame retardant polyphosphoric acid ammonium, and as the antimony based flame retardant, antimony trioxide. These flame retardants are preferably used in a combination of three types of the above flame retardants concurrently in order to obtain excellent flame resistant effects. A weight ratio of the flame retardants to the binder resin is preferable to be in the range of 200 to 1600%, more preferably in the range of 500 to 1500% for the bromine based flame retardant, to be in the range of 3 to 300%, more preferable to be in the range of 50 to 250% for the phosphorus based flame resistant agent, and to be in the range of 3 to 450%, more preferable to be in the range of 50 to 400% for the antimony based flame retardant.

A weight ratio to the composite sheet thereto the metal coating is formed (with a weight of the composite sheet as 100%) is preferable to be in the range of 1 to 10%, more preferable to be in the range of 2 to 8% for the resin, to be in the range of 20 to 65%, more preferable to be in the range of 30 to 55% for the bromine based flame retardant, to be in the range of 2 to 15%, more preferable to be in the range of 3 to 10% for the phosphorus based flame retardant, and to be in the range of 2 to 30%, more preferable to be in the range of 10 to 20% for the antimony based flame retardant.

The present invention will be illustrated in the following Examples.

Measurement methods used in Examples are as follows.

1. Surface Resistance Value (Ω/□)

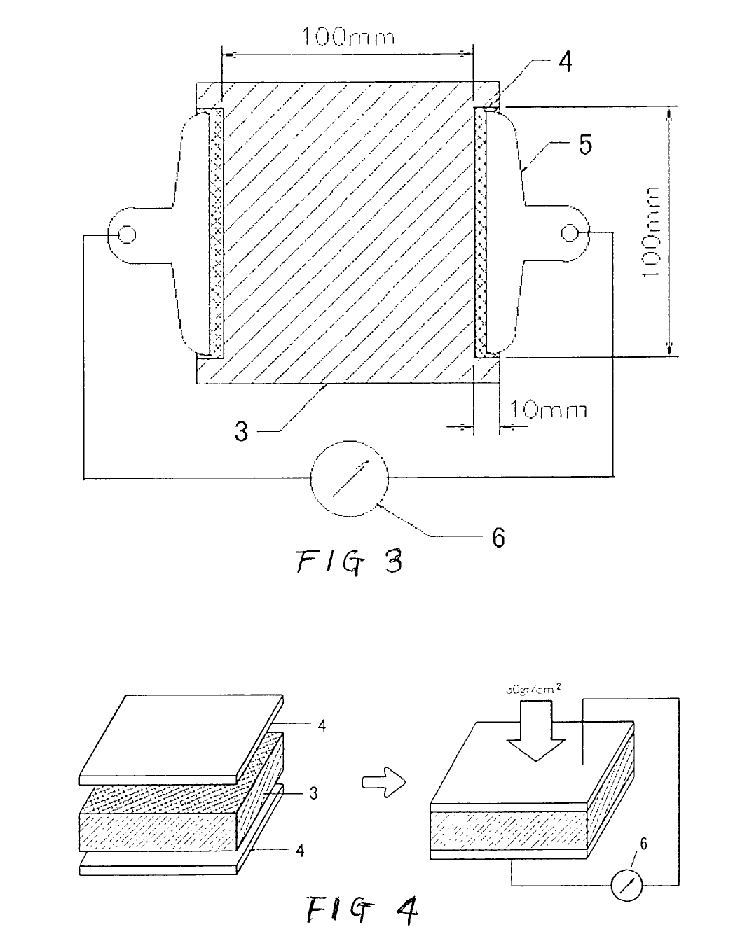

A 120 mm×120 mm test piece is prepared for each of a longitudinal direction and a transversal direction and clamped by two 10 mm×100 mm electrode clips so that a magnitude of the test piece that comes into contact with the electrode may be 10 mm×100 mm and a distance between the two electrodes may be 100 mm, and a resistance value is read with a tester (3220 mΩ Hi TESTER available from HIOKI DENKI K.K). An outline of the measurement method is shown in FIG. 3.

2. Volume Resistance Value (mΩ)

A test piece of a size of 100 mm×100 mm is interposed between two 100 mm×100 mm copper plate electrodes having a weight of 100 g and a weight of 30 g/cm² is disposed thereon. In this state, a resistance value is read with a tester (3220 mΩ Hi TESTER available from HIOKI DENKI K.K). The measurement method is shown in FIG. 4.

3. Shielding properties (dB)

Two copper plates (200 mm×200 mm) each having a thickness of 1 mm and a rectangular opening of 5 mm×25 mm at the center thereof are prepared. At the center portion thereof, a test piece is attached and shielding properties are measured according to KEC method. That is, the test piece is disposed between a transmission antenna and a receiving antenna in a shield box, and an intensity of a received electric field is measured. The obtained value is compared with respect to a value obtained when the test piece is absent, and from the obtained ratio of the test piece, an attenuation rate (dB) can be calculated according to the following formula.

Shielding properties=20 log[(electric field intensity in the absence of shield material)/(electric field intensity in the presence of shield material)] (dB)

4. Flammability

The flammability is measured according to well known UL94 V-O method and UL94 HB method.

### EXAMPLE 1

A spun bonded nonwoven cloth (40 g/m² in weight) made of polyester filament (single thread of 2.2 dtex) is melt-bonded with a polyurethane open cell foam sheet having a thickness of 1.6 mm and a cell density of 40 units/inch, and thereby a composite sheet is obtained. Subsequently, polyester fiber raised knitted fabric (55.6 dtex/24 f, 65 course/45 well, 54 g/m² in weight, thickness 0.47 mm) is melt-bonded on the other surface of the polyurethane foam sheet, thereby a composite sheet having a three-layer structure is obtained.

Next, after the composite sheet is sufficiently cleaned, it is immersed in a 40 degree centigrade aqueous solution containing 0.3 g/L palladium chloride, 30 g/L stannous chloride, and 300 ml/L 36% hydrochloric acid for two minutes followed by washing in water. Subsequently, it is immersed in a 30 degree centigrade aqueous solution of 10% sulfuric acid for five minutes followed by washing in water.

Then, the obtained composite sheet is further immersed at 40 degree centigrade for five minutes in an electroless copper plating liquid containing 7.5 g/L copper sulfate, 30 ml/L 37% formalin, and 85 g/L Rochelle salt followed by washing in water. Subsequently, the obtained composite sheet is immersed at 45 degree centigrade for ten minutes in an electroless nickel plating liquid containing 30 g/L nickel sulfate, 20 g/L sodium hypophosphite and 50 g/L ammonium citrate followed by washing in water. As a result, a 233 g/m² weight and 1.4 mm thick composite sheet in which the surface of the fiber and the internal cell surface of the foam are uniformly plated is obtained.

The obtained composite sheet is immersed in an aqueous solution containing 10% by weight polyester based resin whose solid content is 30% (Vylonal MD1930: a product of Toyobo Co., Ltd.), and 60% by weight flame retardant composition (60% bis(pentabromophenyl)ethane, 10% ammonium polyphosphate and 20% antimony trioxide)), squeezed by use of a mangle followed by drying at 130 degree centigrade. At this time, a pick up is 120%. The obtained composite sheet contains 43% by weight bromine based flame retardant, 7% phosphorus based flame retardant and 14% antimony based flame retardant. The total amount of the rsin and the flame retardant composition is 68% by weight.

Properties thereof are shown in Table 1.

### EXAMPLE 2

A spun bonded nonwoven cloth (40 g/m² in weight) made of polyester filament (single thread of 2.2 dtex) is melt-bonded with a polyurethane open cell foam sheet having a thickness of 1.6 mm and a cell density of 40 units/inch, and thereby a composite sheet is obtained.

Subsequently, polyester fiber raised knitted fabric (55.6 dtex/24 f, cell density 65 course/45 well, 54 g/m² in weight, thickness 0.47 mm) is melt-bonded on the other surface of the polyurethane foam sheet, thereby a composite sheet having a three-layer structure is obtained.

The composite sheet is, similarly to Example 1, pre-treated and plated, and thereby 233 g/m² weight and 1.4 mm thickness three-layer structure composite sheet in which the surface of the fiber and the internal cell surface of the foam are uniformly plated is obtained.

The obtained composite sheet is immersed in an aqueous solution containing 10% by weight of acrylic resin whose solid content is 45% (Primal TR934HS: a product of Rhom and Haas Co., Ltd.), and 60% by weight of flame retardant composition (50% bis(pentabromophenyl)ethane, 5% ammonium polyphosphate), 20% antimony trioxide), squeezed by use of a mangle followed by drying at 130 degree centigrade. At this time, a pick up is 130%. The obtained composite sheet contains 39% by weight bromine based flame retardant, 4% phosphorus based flame retardant and 17% antimony based flame retardant. The total amount of the resin and the flame retardant composition is 64% by weight. Properties thereof are shown in Table 1.

### COMPARATIVE EXAMPLE 1

A spun bonded nonwoven cloth (40 g/m² in weight) made of polyester filament (single thread of 2.2 dtex) is melt-bonded with a polyurethane open cell foam sheet having 1.6 mm thick and 40 units/inch cell density, and thereby a composite sheet is obtained.

Subsequently, polyester fiber raised knitted fabric (55.6 dtex/24 f, cell density 65 course/45 well, 54 g/m² in weight, thickness 0.47 mm) is melt-bonded on the other surface of the polyurethane foam sheet, thereby a composite sheet having a three-layer structure is obtained.

The composite sheet is, similarly to Example 1, pre-treated and plated, and thereby 233 g/m2 weight and 1.4 mm thick three-layer structure composite sheet in which the surface of the fiber and the internal cell surface of the foam are uniformly plated is obtained. Properties thereof are shown in Table 1.

[Reference Example 1]

A spun bonded nonwoven cloth (40 g/m² in weight) made of polyester filament (single thread of 2.2 dtex) is melt-bonded with a polyurethane open cell foam sheet having 1.6 mm thick and 40 units/inch cell density, and thereby a composite sheet is obtained.

Subsequently, polyester fiber raised knitted fabric (55.6 dtex/24 f, density 65 course/45 well, 54 g/m² in weight, thickness 0.47 mm) is melt-bonded on the other surface of the polyurethane foam sheet, thereby a composite sheet having a three-layer structure is obtained.

The composite sheet is, similarly to Example 1, pre-treated and plated, and thereby 233 g/m² weight and 1.4 mm thickness three-layer structure composite sheet in which the surface of the fiber and the internal cell surface of the foam are uniformly plated is obtained.

The obtained composite sheet is immersed in an aqueous solution containing 10% by weight of acrylic resin whose solid content is 45% (Primal TR934HS: a product of Rhom and Haas Japan Co., Ltd.), and 60% by weight of flame retardant composition (50% chlorotetrabromobuthane), squeezed by use of a mangle followed by drying at 130 degree centigrade. At this time, a pick up is 130%. The amount of bromine based flame retardant attached is 39% by weight and the total amount of resin and flame retardant is 45% by weight. Properties thereof are shown in Table 1.

[Reference Example 2]

A spun bonded nonwoven cloth (40 g/m² in weight) made of polyester filament (single thread of 2.2 dtex) is melt-bonded with a polyurethane open cell foam sheet having a thickness of 10 mm and a cell density of 40 units/inch, and thereby a composite sheet is obtained.

Subsequently, polyester fiber raised knitted fabric (55.6 dtex/24 f, density 65 course/45 well, 54 g/m² in weight, thickness 0.47 mm) is melt-bonded on the other surface of the polyurethane foam sheet, thereby a composite sheet having a three-layer structure is obtained.

The composite sheet is, similarly to Example 1, pre-treated and plated, and thereby 398 g/m² weight and 10 mm thickness three-layer structure composite sheet in which the surface of the fiber and the internal surface of the cell are uniformly plated is obtained.

The obtained composite sheet is immersed in an aqueous solution containing 10% by weight of acrylic resin whose solid content is 45% (Primal TR934HS: a product of Rhom and Haas Japan Co., Ltd.), and 60% by weight of flame retardant composition (50% bis (pentabromophenyl)ethane, 5% ammonium polyphosphate), and 20% antimony trioxide), squeezed by use of a mangle followed by drying at 130 degree centigrade. At this time, a pick up is 130%. The obtained composite sheet contains 39% by weight bromine based flame retardant, 4% phosphorus based flame retardant and 16% antimony based flame retardant. The total amount of the resin and the flame retardant composition is 64% by weight. Properties thereof are shown in Table 1.

TABLE 1

| | Surface resistance value | | Volume | Flammability test results | | | | |
|---|---|---|---|---|---|---|---|---|
| | (Ω/□) | | resistance | according to UL94 | | Shield properties (dB) | | |
| Test piece | Warp | Weft | value (mΩ) | HB method | V-O method | 10 MHz | 100 MHz | 1 GHz |
| Example 1 | 0.08 | 0.09 | 17 | Accepted | Accepted | 100 | 88 | 80 |
| Example 2 | 0.09 | 0.07 | 18 | Accepted | Accepted | 99 | 89 | 85 |
| Comparative | 0.07 | 0.08 | 16 | Not accepted | Not accepted | 100 | 90 | 88 |
| Example 1 | | | | | | | | |
| Reference | 0.09 | 0.08 | 18 | Not accepted | Not accepted | 102 | 89 | 80 |
| Example 1 | | | | | | | | |
| Reference | 0.07 | 0.09 | 19 | Slightly | Slightly | 101 | 93 | 87 |
| Example 2 | | | | not accepted | not accepted | | | |

What is claimed is:

1. A flame resistant conductive material, comprising:
a composite sheet in which fiber cloth is bonded with one or both surfaces of an open cell foam sheet;
a conductive metal coating adhered to an entire surface of the composite sheet so as to maintain the open cell characteristics of the foam sheet; and
a flame retardant composition adhered on the metal coating.

2. A flame resistant conductive material according to claim 1, wherein the thickness of the composite sheet is in the range of 0.5 mm to 7 mm.

3. A flame resistant conductive material according to claim 1, wherein the flame retardant composition comprises a bromine-based flame retardant, a phosphorus-based flame retardant, and an antimony-based flame retardant.

4. A flame resistant conductive material according to claim 1, wherein the bromine-based flame retardant is an aromatic bromine compound, the phosphorus-based flame retardant is ammoniumpolyphosphate a, and the antimony-based flame retardant is antimony trioxide.

5. A flame resistant conductive material according to claim 1, wherein the foam sheet is a soft polyurethane foam sheet.

6. A flame resistant conductive material according to claim 1, wherein the flame resistant conductive material is an electromagnetic wave shield gasket material.

7. A flame resistant conductive material according to claim 1, wherein the flame retardant composition is adhered by use of a binder resin.

8. A flame resistant conductive material according to claim 7 containing, with respect to a weight of the composite sheet having the metal coating, 1 to 10% by weight of the binder resin, 20 to 65% by weight of the bromine based flame retardant, 2 to 15% by weight of the phosphorus based flame retardant, and 2 to 30% by weight of antimony based flame retardant.

9. A method for producing a flame resistant conductive material, which comprises steps of:
providing a composite sheet in which fiber cloth is bonded on one or both surfaces of an open cell foam sheet;
adhering a conductive metal to the composite sheet by means of plating so as to maintain the open cell characteristics of the foam sheet;
adhering a flame retardant composition to the obtained composite sheet having the conductive metal coating so that the flame retardant layer is adhered on a substantially entire surface of the metal coating including the inner surfaces of the open cells.

10. A method for producing a flame resistant conductive material according to claim 9, wherein the bonding of the foam sheet and fiber cloth is carried out either by melt-bonding one or both surfaces of the foam sheet to the fiber cloth, or by adhering one or both surfaces of the foam sheet to the fiber cloth by use of an adhesive.

11. A method for producing a flame resistant conductive material according to claim 9, wherein the adhering of the flame retardant layer is carried out by means of an immersion using a coating liquid containing the flame retardant composition and a binder resin.

12. A method for producing a flame resistant conductive material according to claim 11, wherein the binder resin is a water soluble resin or an emulsion-forming resin.
